(19) United States
(12) Patent Application Publication
(10) Pub. No.: US 2020/0300364 A1
(43) Pub. Date: Sep. 24, 2020

(54) SEALING APPARATUS

(71) Applicant: NOK CORPORATION, Tokyo (JP)

(72) Inventor: Nobuyuki EGUCHI, Kitaibaraki-shi, Ibaraki (JP)

(21) Appl. No.: 16/754,964

(22) PCT Filed: Sep. 27, 2018
(86) PCT No.: PCT/JP2018/035964

§ 371 Date: Apr. 9, 2020

(30) Foreign Application Priority Data
Oct. 13, 2017 (JP) 2017-199668

(51) Int. Cl. F16J 15/3212; F16J 15/3204

(52) U.S. Cl. CPC F16J 15/3212; F16J 15/3204

(57) ABSTRACT

A sealing apparatus capable of suppressing an increase in sliding resistance while sealing performance is maintained over a long period of time is provided. A leaf spring 200 is provided with, at intervals in a circumferential direction, a plurality of projections 210 which are configured to dig into a seal member 100 as, in accordance with a shaft 600 being inserted into a shaft hole of a housing 700, a radially inward portion of the seal member 100 is deformed to curve toward a fluid-to-be-sealed side and a radially inward portion of the leaf spring 200 is deformed to curve along the seal member 100.

### CROSS-REFERENCE TO RELATED APPLICATIONS

This application is a National Stage of International Application No. PCT/JP2018/035964, filed Sep. 27, 2018 (now WO 2019/073808A1), which claims priority to Japanese Application No. 2017-199668, filed Oct. 13, 2017. The entire disclosures of each of the above applications are incorporated herein by reference.

### FIELD

The present disclosure relates to a sealing apparatus including a seal member made of polytetrafluoroethylene.

### BACKGROUND

Further stabilization of sealing performance is desired in view of coping with environmental regulations and the like regarding sealing apparatuses for sealing an annular gap between a shaft and a housing which rotate relative to each other in an exhaust gas system such as EGR. In consideration thereof, the applicant has proposed a technique which relates to a sealing apparatus which uses a seal member made of polytetrafluoroethylene (PTFE) which has superior heat resistance and little sliding abrasion and which uses a leaf spring as measures to settling of the seal member due to a creep phenomenon which occurs over time (refer to PTL 1). A sealing apparatus according to a conventional example will now be described with reference to FIGS. 8 to 10.

FIG. 8 is a schematic sectional view of a sealing apparatus according to the conventional example. FIGS. 9 and 10 are schematic sectional views of a sealing structure according to the conventional example. It should be noted that FIG. 9 shows an initial state and FIG. 10 shows a state after long-term use. Note that FIGS. 8 to 10 show cross sections and depth lines have been omitted.

A sealing apparatus 800 according to this conventional example includes a metal ring 830, a seal member 810 made of PTFE, a leaf spring 820, and a metal fixing ring 840 fixed to an inner circumferential surface side of the metal ring 830. The seal member 810 and the leaf spring 820 are fixed to the metal ring 830 by the fixing ring 840. The seal member 810 is configured to be in close contact with and slide freely on an outer circumferential surface of a shaft 600 in a state in which its radially outward portion is fixed to the metal ring 830 and its radially inward portion is deformed to curve toward a fluid-to-be-sealed side (a high pressure side (H)). The leaf spring 820 is configured so that its radially outward portion is fixed to the metal ring 830 and its radially inward portion is deformed to curve along the seal member 810, and the leaf spring 820 presses a vicinity of an end of a radially inward portion of the seal member 810 toward an outer circumferential surface of the shaft 600.

The leaf spring 820 of the sealing apparatus 800 configured as described above can keep a vicinity of the end of the radially inward portion of the seal member 810 in close contact with the outer circumferential surface of the shaft 600 even if settling of the seal member 810 occurs. Thus, sealing performance is maintained over a long period of time.

However, the seal member 810 is subjected to pressure of the fluid to be sealed in a high-temperature environment over a long period of time. Then a creep phenomenon advances over time and a curved portion between a planar portion and a cylindrical portion of the seal member 810 has been deformed in a protruding direction toward a side opposite to the fluid-to-be-sealed side (a low-pressure side (L)) as shown in FIG. 10. Thus, a sliding area between the seal member 810 and the shaft 600 gradually increases. While a range of the sliding portion between the seal member 810 and the shaft 600 is S1 in the initial state illustrated in FIG. 9, the range of the sliding portion between the seal member 810 and the shaft 600 has become S2 (>S1) in a state after long-term use illustrated in FIG. 10.

As described above, the leaf spring 820 of the conventional sealing apparatus 800 causes a sliding area between the seal member 810 and the shaft 600 to increase over time, though it enables sealing performance to be maintained over a long period of time. This leads to increase in sliding resistance, which in turn increases torque.

### CITATION LIST

### Patent Literature

[PTL 1] Japanese Patent Application Laid-open No. 2015-203491

### SUMMARY

### Technical Problem

An object of the present disclosure is to provide a sealing apparatus capable of suppressing an increase in sliding resistance while sealing performance is maintained over a long period of time.

### Solution to Problem

In order to achieve the object described above, the present disclosure adopts the following means.

Specifically, a sealing apparatus according to the present disclosure is a sealing apparatus configured to seal an annular gap between a shaft and a housing which rotate relative to each other, the sealing apparatus including: a metal ring configured to be fixed to a shaft hole provided in the housing; a seal member having a planar and annular member made of polytetrafluoroethylene and configured so that a radially outward portion thereof is fixed to the metal ring and a radially inward portion thereof is in close contact with and slide freely on an outer circumferential surface of the shaft in a state being deformed to curve toward a fluid-to-be-sealed side on which a fluid to be sealed is sealed; and a leaf spring having a planar and annular metal member, a radially outward portion thereof being fixed to the metal ring and a radially inward portion thereof being configured to be deformed to curve along the seal member, the leaf spring pressing the seal member radially inwardly toward the outer circumferential surface of the shaft, wherein the leaf spring is provided with, at intervals in a circumferential direction, a plurality of projections configured to dig into the seal member as, in accordance with the shaft being inserted into the shaft hole, the radially inward portion of the seal member is deformed to curve toward the fluid-to-be-sealed side and the radially inward portion of the leaf spring is deformed to curve along the seal member.

Note that the “fluid-to-be-sealed side” refers to a side on which a fluid to be sealed is configured to be sealed. Thus, the side configured to have a fluid to be sealed is the “fluid-to-be-sealed side” though in a state where a fluid to be sealed is not actually sealed.

Since the seal member of the sealing apparatus according to the present disclosure is constituted by the planar and annular member made of polytetrafluoroethylene and configured to be in close contact with and slide freely on the outer circumferential surface of the shaft in a state in which the radially outward portion thereof is fixed to the metal ring and the radially inward portion is deformed to curve toward the fluid-to-be-sealed side, superior heat resistance and the like can be realized and sliding abrasion can be reduced as compared to a sealing apparatus having a seal member made of a rubber-like elastic body. In addition, since the sealing apparatus according to the present disclosure includes the leaf spring which presses the seal member radially inwardly toward the outer circumferential surface of the shaft, stable sealing performance can be maintained over a long period of time even if settling of the seal member itself occurs.

Since the leaf spring of the sealing apparatus according to the present disclosure is provided with, at intervals in the circumferential direction, a plurality of projections configured to dig into the seal member, the seal member can be prevented from moving relative to the leaf spring in portions where the plurality of projections have dug into the seal member. This prevents the seal member from being deformed in a protruding direction toward a side opposite to the fluid-to-be-sealed side even when subjected to pressure of the fluid to be sealed. This suppresses an increase in a sliding area between the seal member and the shaft.

Further, since the projections are configured to dig into the seal member as, in accordance with the shaft being inserted into the shaft hole, the radially inward portion of the seal member is deformed to curve toward the fluid-to-be-sealed side and the radially inward portion of the leaf spring is deformed to curve along the seal member, the seal member and the leaf spring can be deformed not forcedly, thus an occurrence of distortion in any one of the seal member and the leaf spring is suppressed, and detachment of the projections having dug into the seal member is suppressed.

The projections may be configured to dig into positions on the reverse side of portions in the seal member which are configured to be in close contact with and slide freely on the outer circumferential surface of the shaft.

This ensures the projections to dig into the seal member.

The projections may extend radially inwardly toward the fluid-to-be-sealed side.

This prevents the projections having dug into the seal member from coming off even when the seal member is subjected to pressure of the fluid to be sealed.

Note that the respective configurations described above can be adopted in combination with each other to the greatest extent feasible.

### Advantageous Effects of the Disclosure

As described above, according to the present disclosure, an increase in sliding resistance can be suppressed while sealing performance is maintained over a long period of time.

### DRAWINGS

FIG. 1 is a front view of a sealing apparatus according to an embodiment of the present disclosure.

FIG. 2 is a rear view of the sealing apparatus according to the embodiment.

FIG. 3 is a rear view of a leaf spring according to the embodiment.

FIG. 4 is a schematic sectional view of the leaf spring according to the embodiment.

FIG. 5 is a schematic sectional view of the sealing apparatus according to the embodiment.

FIG. 6 is a schematic sectional view of a sealing structure according to the embodiment.

FIG. 7 is a partly sectional perspective view of the sealing apparatus according to the embodiment.

FIG. 8 is a schematic sectional view of a sealing apparatus according to a conventional example.

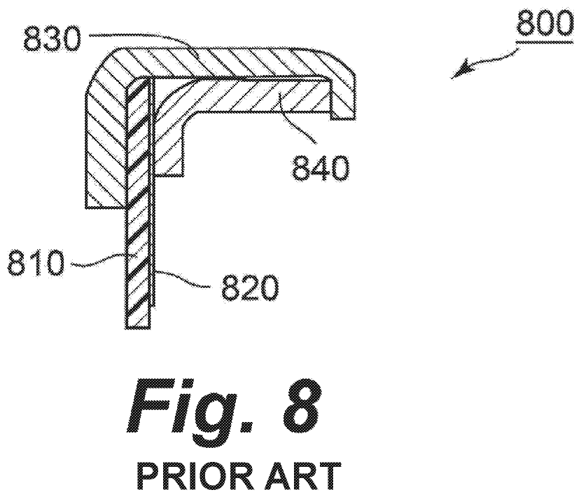

FIG. 9 is a schematic sectional view of a sealing structure according to the conventional example.

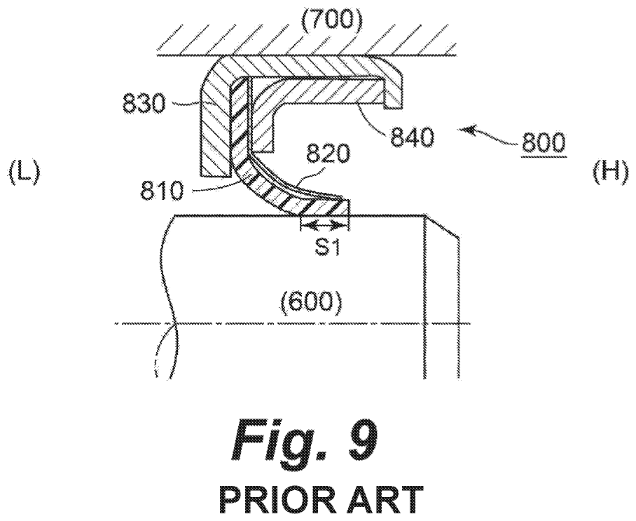

FIG. 10 is a schematic sectional view of the sealing structure according to the conventional example.

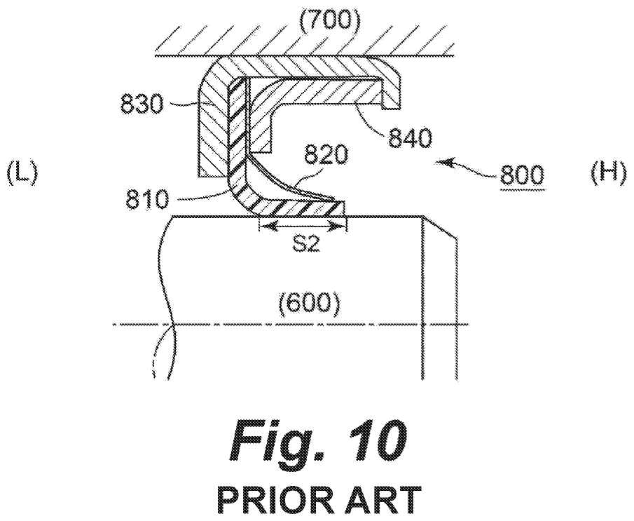

### DETAILED DESCRIPTION

Hereinafter, a mode for implementing the present disclosure will be described in detail by way of example of an embodiment with reference to the drawings. However, it is to be understood that dimensions, materials, shapes, relative arrangements, and the like of components described in the embodiment are not intended to limit the scope of the disclosure thereto unless specifically noted otherwise.

### Embodiment

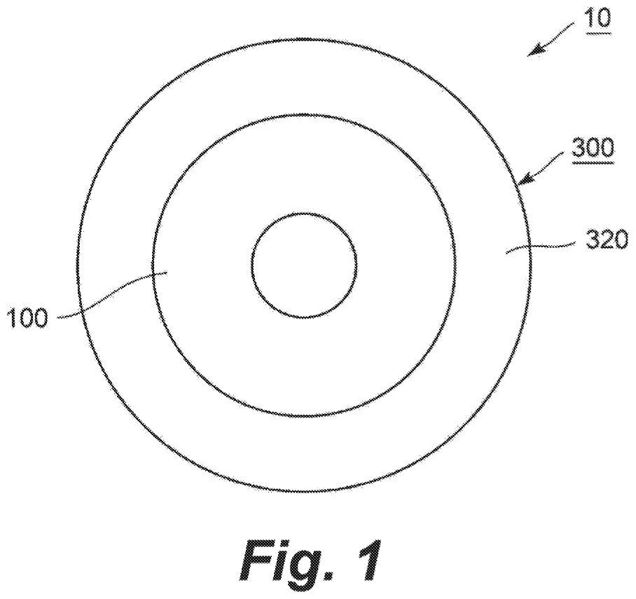

A sealing apparatus according to an embodiment of the present disclosure will be described with reference to FIGS. 1 to 7. A sealing apparatus 10 according to the present embodiment is used in, for example, an exhaust gas system such as EGR in order to seal an annular gap between a shaft 600 and a housing 700 which rotate relative to each other. Thus, the sealing apparatus 10 may be used in a high-temperature environment. Hereinafter, a “fluid-to-be-sealed side” refers to a side on which a fluid-to-be-sealed is configured to be sealed. Thus, the side configured to have a fluid to be sealed is “fluid-to-be-sealed side” though in a state where a fluid to be sealed is not actually sealed. Pressure on the fluid-to-be-sealed side reaches higher than that on a side opposite thereto. Thus, in the following description, the fluid-to-be-sealed side may be referred to as a high-pressure side (H) and a side opposite thereto may be referred to as a low-pressure side (L).

### <Sealing Apparatus>

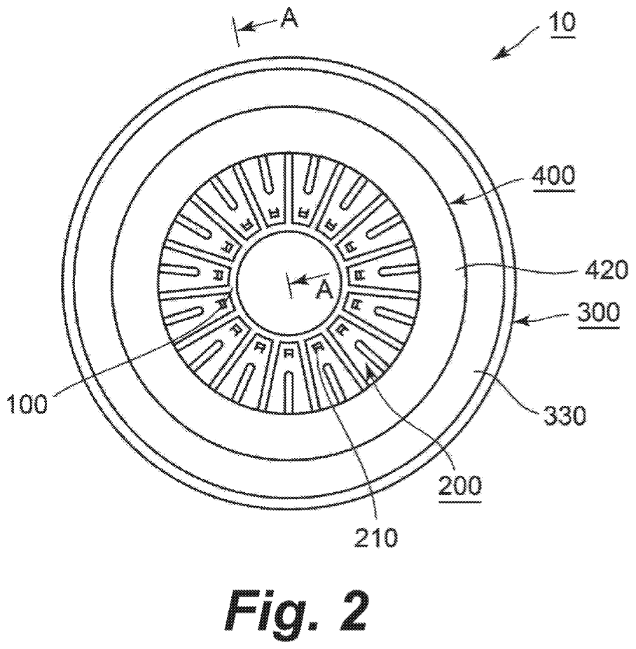

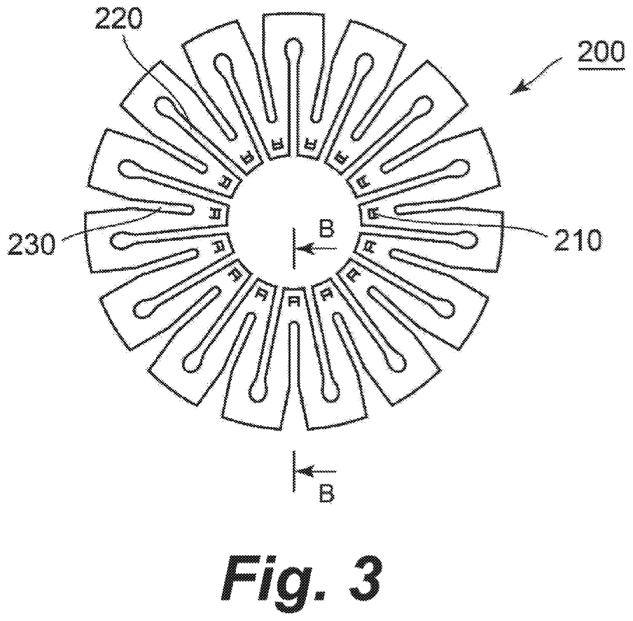

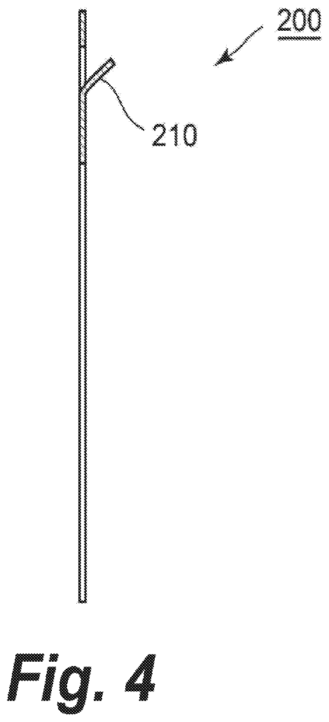

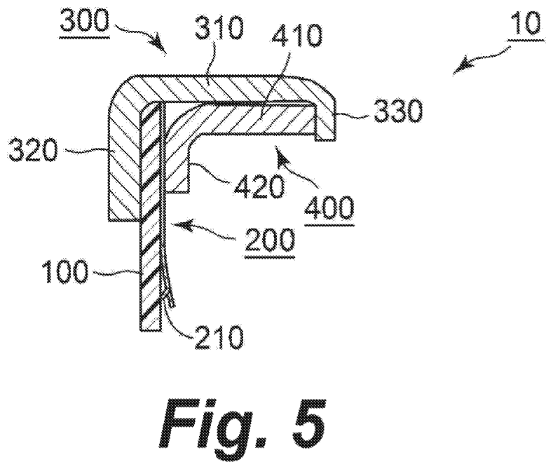

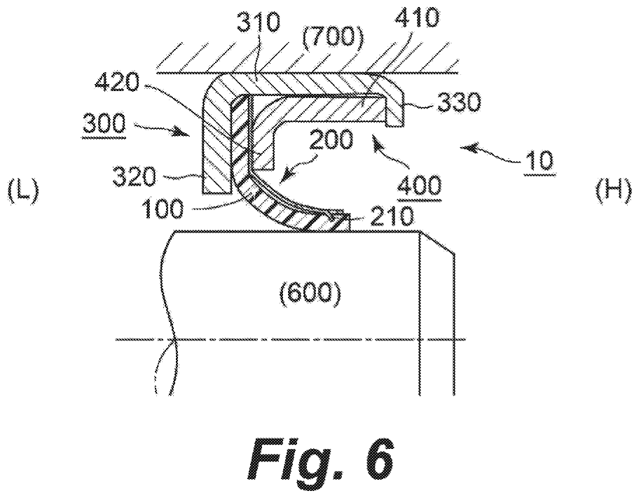

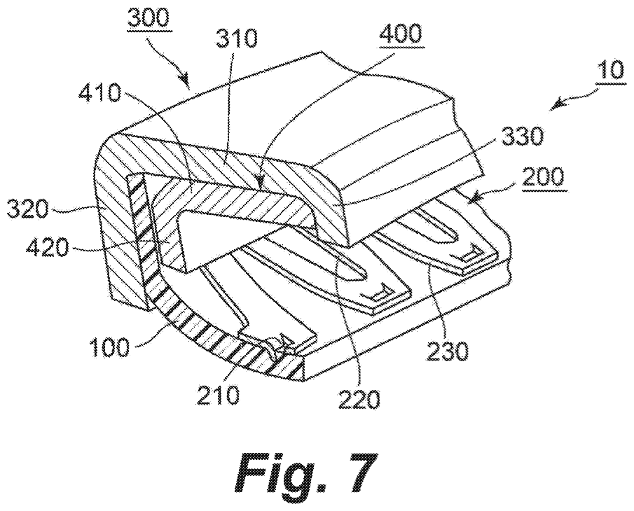

A configuration of the sealing apparatus 10 will be described. FIG. 1 is a front view of a sealing apparatus according to the embodiment. FIG. 2 is a rear view of the sealing apparatus. FIG. 3 is a rear view of a leaf spring according to the embodiment. FIG. 4 is a schematic sectional view of the leaf spring along the line B-B in FIG. 3. FIG. 5 is a schematic sectional view of the sealing apparatus along the line A-A in FIG. 2. FIG. 6 is a schematic sectional view of a sealing structure. Note that FIGS. 5 and 6 show cross sections and depth lines have been omitted. FIG. 7 is a partly sectional perspective view of the sealing apparatus. Note that FIG. 7 is a perspective view of a vicinity of a section of the sealing apparatus in the sealing structure according to the embodiment seen in an oblique direction and that a shaft and a housing are omitted in the drawing.

The sealing apparatus 10 includes a metal ring 300, a seal member 100, a leaf spring 200, and a metal fixing ring 400 fixed to an inner circumferential surface side of the metal ring 300. The metal ring 300 includes a cylindrical part 310, an inward flange part 320 which extends radially inwardly from one end side of the cylindrical part 310, and a swaging part 330 which is formed on the other end side of the cylindrical part 310 by being bent radially inwardly. The cylindrical part 310 is fitted in a state in close contact with an inner circumferential surface of a shaft hole provided in the housing 700. Thus, sufficient sealing performance can be achieved between an outer circumferential surface of the metal ring 300 and the inner circumferential surface of the shaft hole of the housing 700 when the housing 700 is made of cast metal (for example, cast aluminum). This ensures sealing performance even if a plurality of minute depression such as blowholes exist on the inner circumferential surface of the shaft hole of the housing 700. Note that the “one end side” described above corresponds to the “low-pressure side (L)” and the “other end side” described above corresponds to the “high-pressure side (H)” in the sealing structure.

The seal member 100 includes a planar and annular member made of polytetrafluoroethylene (PTFE). Characteristics of PTFE include superior heat resistance, pressure resistance, and chemical resistance as well as low sliding abrasion. The seal member 100 is configured so that a radially outward portion thereof is fixed to the metal ring 300 and a radially inward portion thereof is in close contact with and slide freely on an outer circumferential surface of the shaft 600 in a state being deformed to curve toward the high-pressure side (H).

The leaf spring 200 includes a planar and annular metal member. The leaf spring 200 is configured so that a radially outward portion thereof is fixed to the metal ring 300 and a radially inward portion thereof is deformed to curve along the seal member 100 and presses the radially inward side of the seal member 100 toward the outer circumferential surface of the shaft 600. The leaf spring 200 is provided with, at intervals in the circumferential direction, a plurality of inner slits 220 which extend from an end on an inner circumferential surface side toward an end on an outer circumferential surface side. The leaf spring 200 is provided with, at intervals in the circumferential direction, a plurality of outer slits 230 which extend from the end on the outer circumferential surface side toward the end on the inner circumferential surface side. The inner slits 220 and the outer slits 230 are alternately provided in the circumferential direction. The leaf spring 200 is provided with, at intervals in the circumferential direction, a plurality of projections 210 configured to dig into the seal member 100.

The fixing ring 400 includes a cylindrical part 410, which is fixed to an inner circumferential surface side of the metal ring 300, and an inward flange part 420, which extends radially inwardly from one end side of the cylindrical part 410. The swaging part 330 is formed by bending an end portion on the other end side in the metal ring 300 radially inwardly so as to abut against an end of the fixing ring 400 in a state in which the seal member 100, the leaf spring 200, and the fixing ring 400 are arranged on the inner circumferential surface side of the metal ring 300. The radially outward side end of the seal member 100 and the radially outward side end of the leaf spring 200 are fixed to the metal ring 300 by being compressed between the inward flange part 320 and the fixing ring 400.

### <Mounting Method and State in Use of Sealing Apparatus>

A mounting method and a sealing structure of the sealing apparatus 10 will now be described with reference to FIGS. 5 to 7. The sealing apparatus 10 configured as described above is inserted into a shaft hole provided in the housing 700 and fitted into the shaft hole. The outer circumferential surface of the cylindrical part 310 of the metal ring 300 in the sealing apparatus 10 comes into close contact with an inner circumferential surface of the shaft hole. The shaft 600 is inserted from a left side in FIG. 6 (the low-pressure side (L) in use) toward a right side in FIG. 6 (the high-pressure side (H) in use). Thus, radially inward side ends of the seal member 100 and the leaf spring 200 are pushed by the shaft 600. Then the seal member 100 and the leaf spring 200 deform so that the radially inward side portions relative to portions compressed between the inward flange part 320 and the fixing ring 400 curve toward the fluid-to-be-sealed side. Thus, an inner circumferential surface in a vicinity of a distal end in a curved portion of the seal member 100 comes into close contact with the outer circumferential surface of the shaft 600. In addition, an inner circumferential surface in a vicinity of a distal end in a curved portion of the leaf spring 200 comes into close contact with an outer circumferential surface in a vicinity of the distal end in the curved portion of the seal member 100. Due to elastic restoring force of the leaf spring 200, a vicinity of the distal end in the curved portion of the seal member 100 is pressed toward the outer circumferential surface of the shaft 600 by a portion of the leaf spring 200 near the distal end.

### <Projections of Leaf Spring>

The projections 210 provided on the leaf spring 200 will now be described in greater detail. The projections 210 are configured not to dig into the seal member 100 in a state where the sealing apparatus 10 is assembled, that is, a state prior to insertion of the shaft 600. The elastic force of the leaf spring 200 is set so that, in this state, distal ends of the projections 210 abut against the seal member 100 while a radially inward portion of the leaf spring 200 is slightly deflected, and the projections 210 are prevented from digging into the seal member 100 as illustrated in FIG. 5.

In addition, the projections 210 are configured to dig into the seal member 100 as, in accordance with the shaft 600 being inserted into the shaft hole of the housing 700, the radially inward portion of the seal member 100 is deformed to curve toward the fluid-to-be-sealed side and the radially inward portion of the leaf spring 200 is deformed to curve along the seal member 100.

When the radially inward portion of the seal member 100 deforms and the radially inward portion of the leaf spring 200 deforms in accordance with insertion of the shaft 600, a radially inward portion of the seal member 100 becomes sandwiched between the shaft 600 and the leaf spring 200. Thus, pressing force of the projections 210 provided on the leaf spring 200 on the seal member 100 increases as compared to that in a state prior to the insertion of the shaft 600, and then the projections 210 dig into the seal member 100.

Note that the projections 210 are configured to dig into positions on the reverse side of portions in the seal member 100 which are configured to be in close contact with and slide freely on the outer circumferential surface of the shaft 600. In addition, the projections 210 are configured to extend radially inwardly toward the fluid-to-be-sealed side as illustrated in FIG. 5.

### Advantages of Sealing Apparatus According to Present Embodiment

Since the seal member 100 of the sealing apparatus 10 includes the planar and annular member made of PTFE and configured to be in close contact with and slide freely on the outer circumferential surface of the shaft 600 in a state in which the radially outward portion thereof is fixed to the metal ring 300 and the radially inward portion is deformed to curve toward the fluid-to-be-sealed side, superior heat resistance and the like can be realized and sliding abrasion can be reduced as compared to a sealing apparatus having a seal member made of a rubber-like elastic body. In addition, since the sealing apparatus 10 includes the leaf spring 200 which presses the seal member 100 radially inwardly toward the outer circumferential surface of the shaft 600, stable sealing performance can be maintained over a long period of time even if settling of the seal member 100 itself occurs.

Since the leaf spring 200 is provided with, at intervals in the circumferential direction, a plurality of projections 210 configured to dig into the seal member 100, the seal member 100 can be prevented from moving relative to the leaf spring 200 in portions where the plurality of projections 210 have dug into the seal member 100. This prevents the seal member 100 from being deformed in a protruding direction toward the low-pressure side (L) even when subjected to pressure of the fluid to be sealed. Assuming that a seal member is solely pressed by a leaf spring toward an outer circumferential surface of a shaft, the seal member would be gradually deformed to protrude toward a low-pressure side due to a creep phenomenon under a high-temperature environment and sustained pressure of a fluid to be sealed. Further, the seal member would gradually slide toward the low-pressure side (L) relative to the leaf spring in a pressed portion of the seal member by the leaf spring.

In contrast, the seal member 100 of the sealing apparatus 10 according to the present embodiment can be prevented from moving relative to the leaf spring 200 in portions where the plurality of projections 210 have dug into the seal member 100 as described above. This prevents the seal member 100 from being deformed in a protruding direction toward the low-pressure side (L). This suppresses an increase in a sliding area between the seal member 100 and the shaft 600. Thus, an increase in sliding resistance between the seal member 100 and the shaft 600 can be suppressed.

Further, since the projections 210 are configured to dig into the seal member 100 as, in accordance with the shaft 600 being inserted into the shaft hole, the radially inward portion of the seal member 100 is deformed to curve toward the fluid-to-be-sealed side and the radially inward portion of the leaf spring 200 is deformed to curve along the seal member 100, the seal member 100 and the leaf spring 200 can be deformed not forcedly, thus an occurrence of distortion in any one of the seal member 100 and the leaf spring 200 is suppressed, and detachment of the projections 210 having dug into the seal member 100 is suppressed.

Specifically, the seal member 100 and the leaf spring 200 are deformed with different degrees of bending. Thus, assuming that the projections 210 are configured to dig into the seal member 100 in a state prior to deformation, distortion would occur in any one of the seal member 100 and the leaf spring 200 during deformation, and hence the projections 210 which had dug into the seal member 100 would come off easily. In contrast, in the present embodiment, since the projections 210 are configured to dig into the seal member 100 during the deformation process of the seal member 100 and the leaf spring 200, an occurrence of distortion in any one of the seal member 100 and the leaf spring 200 can be suppressed.

In addition, since the projections 210 are configured to dig into positions on the reverse side of portions in the seal member 100 which are configured to be in close contact with and slide freely on the outer circumferential surface of the shaft 600, the seal member 100 is directly sandwiched by the projections 210 and the shaft 600 from both surfaces' sides. This ensures the projections 210 to dig into the seal member 100.

Further, since the projections 210 are configured to extend radially inwardly toward the fluid-to-be-sealed side, the projections 210 having dug into the seal member 100 can be prevented from coming off even when the seal member 100 is subjected to pressure of the fluid to be sealed.

### (Other)

Positions where the projections 210 are provided on the leaf spring 200 are not limited to the positions shown in the embodiment described above.

### REFERENCE SIGNS LIST

10 Sealing apparatus
100 Seal member
200 Leaf spring
210 Projection
220 Inner slit
230 Outer slit
300 Metal ring
310 Cylindrical part
320 Inward flange part
330 Swaging part
400 Fixing ring
410 Cylindrical part
420 Inward flange part
600 Shaft
700 Housing

1. A sealing apparatus configured to seal an annular gap between a shaft and a housing which rotate relative to each other, the sealing apparatus comprising:
a metal ring configured to be fixed to a shaft hole provided in the housing;
a seal member having a planar and annular member made of polytetrafluoroethylene and configured so that a radially outward portion thereof is fixed to the metal ring and a radially inward portion thereof is in close contact with and slide freely on an outer circumferential surface of the shaft in a state being deformed to curve toward a fluid-to-be-sealed side on which a fluid to be sealed is sealed; and
a leaf spring having a planar and annular metal member, a radially outward portion thereof being fixed to the metal ring and a radially inward portion thereof being configured to be deformed to curve toward the seal member, the leaf spring pressing the seal member radially inwardly toward the outer circumferential surface of the shaft, wherein
the leaf spring is provided with, at intervals in a circumferential direction, a plurality of projections configured to dig into the seal member as, in accordance with the shaft being inserted into the shaft hole, the radially inward portion of the seal member is deformed to curve toward the fluid-to-be-sealed side and the radially inward portion of the leaf spring is deformed to curve along the seal member.

2. The sealing apparatus according to claim 1, wherein the projections are configured to dig into positions on the reverse side of portions in the seal member which are configured to be in close contact with and slide freely on the outer circumferential surface of the shaft.

3. The sealing apparatus according to claim 1, wherein the projections extend radially inwardly toward the fluid-to-be-sealed side.

4. The sealing apparatus according to claim 2, wherein the projections extend radially inwardly toward the fluid-to-be-sealed side.
